(19) United States
(12) Patent Application Publication
(10) Pub. No.: US 2010/0093551 A1
(43) Pub. Date: Apr. 15, 2010

(54) Liquid Transfer and Filter System

(75) Inventor: Jean I. Montagu, Brookline, MA (US)

Correspondence Address: FISH & RICHARDSON PC, P.O. BOX 1022, MINNEAPOLIS, MN, 55440-1022, US

(73) Assignee: Decision Biomarkers, Inc.

(21) Appl. No.: 12/576,856

(22) Filed: Oct. 9, 2009

Related U.S. Application Data
(60) Provisional application No. 61/103,984, filed on Oct. 9, 2008.

(51) Int. Cl. C40B 30/00; B01D 35/00; B01D 29/11; B01D 29/60; B65B 3/12

(52) U.S. Cl. 506/7; 210/235; 210/120; 210/206; 210/637; 141/67

(57) ABSTRACT

A mechanically simple, small, hand held device is provided based on filtering and pressure equilibration techniques involving a unique hand-operating sequence that produces air pressure within the collection tube and the device, to enable simple and rapid extraction of blood serum or plasma or other filtrate in milliliter quantities from a collected sample. The device can also provide dilution of the serum, plasma or filtrate, capture of unwanted molecular constituents or dispensing of desired reagents. Pipette extraction of diluted or undiluted blood plasma, serum or filtrate from the device can also be achieved via a septum. The device permits all functions to be performed rapidly and with minimum danger of exposure of the operator or contamination of the sample while enabling standard evacuated collection tubes to be used.

### CROSS-REFERENCE TO RELATED APPLICATION

This application claims priority to U.S. Provisional Application Ser. No. 61/103,984, filed on Oct. 9, 2008.

### TECHNICAL FIELD

This invention relates to the separation of blood cells from whole blood to obtain small quantities of plasma or serum that is free of blood cells. It also relates to the optional dilution or treatment of separated fluid (e.g. plasma or serum) and to performance of bio-array assays and other diagnostic procedures using small quantities of the separated fluid at natural or diluted concentrations. (“Plasma” refers to the liquid component of whole blood constituting about one half of the volume of blood, the blood cells constituting the remainder of the volume. “Blood serum” is blood plasma from which fibrinogen or other clotting factors have been removed.)

The invention also relates more generally to a simple and safe system for transferring liquid, e.g., of volume of a fraction of a milliliter or a few milliliters, from a sealed collection container, and for using that system for producing filtered or treated liquid, for dispensing agents into liquid passing through filter material, and for capturing a molecular constituent of liquid passing through filter material.

### BACKGROUND

As traditionally conducted, a set of adult blood tests necessitates collection of whole blood with 3 to 6 evacuated blood collection tubes (Vacutainer™, Becton Dickinson and Company, East Rutherford, N.J.) each with 10 milliliter capacity. Plasma is typically obtained when blood is processed by centrifugal separation or filtering within minutes from being drawn, if unaltered with added substances. Serum is obtained after blood has been kept for a period of time so that fibrinogen forms a clot which sinks to the bottom of the container. Serum is then separated by pipetting, centrifuging or filtering.

The availability of sensitive biological assays has made it possible to run accurate tests employing much smaller sample volumes than has been traditional. For instance, multiple tests can be preformed employing less than 1 milliliter of plasma or serum using bio-array techniques. No simple and rapidly operable device is presently available for providing serum or plasma extraction at this size volume.

The need for small volume blood collection itself has been recognized for blood tests for infants and small animals. Evacuated collection tubes have long been available for obtaining a fraction of a milliliter or a few milliliters of blood.

Extremely small blood volumes have also traditionally been obtained by use of a puncture wound. The finger for instance is pricked with a lancet and then squeezed until a fluid drop of, e.g., 10-20 μ.l, is obtained.

In most cases of use of small samples for assays, further manipulations have been required once the sample of whole blood has been obtained. The sample may be mixed with a stabilizing agent to permit storage at room temperature prior to separation. Depending on the assay for which the sample is intended, it may also be necessary to add diluents and/or reagents, or it may be necessary to manipulate the sample physically, for example by centrifuging the sample as a means of removing blood cells.

Current methods of achieving small volumes of blood plasma or serum thus involve numerous steps, employing multiple pieces of equipment and disposable items. Various kits are available for these purposes, examples being Unopette® (Becton Dickinson and Company), Fisherbrand® microhematocrit and capillary tubes (Fisher Scientific Company, Hampton N.H.), and the StatSampler® capillary blood collection kit (StatSpin, Norwood, Mass.). Each relies on multiple separate components for performing the functions of sample collection, processing, and recovery.

Prior art patents in the general field include U.S. Pat. Nos. 2,460,641; 4,883,068; 4,343,705; 4,477,575; 4,540,492; 4,828,716; 4,906,375; 5,030,341; 5,181,940; 5,308,508; 5,413,246; 5,555,920; 5,681,529; 5,759,866; 5,919,356; 6,261,721; 6,406,671; 6,410,334; 6,465,256; 6,471,069; 6,479,298; 6,497,325; 6,516,953; 6,537,503; 6,755,802; 6,803,022; 6,821,789; 7,070,721 and 7,153,477.

It is desirable to work efficiently with blood samples of the order of 1 to 5 milliliter. Most protein analyzers for instance necessitate 50 to 100 micro-liters per test and it is common to require 10 tests. Multiplexed biomarker cassettes, e.g. those employing micro arrays, typically run 8 to 12 assays simultaneously and call for 100 to 200 micro-liter of serum or plasma.

The device made possible by the present disclosure can meet these needs without requiring use of a centrifuge or other inconvenient separation techniques, thus enabling simple and rapid sterile separation at point of collection or point of treatment.

### SUMMARY

A mechanically simple, small, hand held device is provided based on pressure equilibration techniques, involving a unique hand-operating sequence that produces compressed air within the collection tube followed by expulsion of liquid from the tube by the air. This is advantageously followed by forced transfer of the liquid through filter medium. The device enables simple and rapid extraction of blood serum or plasma in milliliter quantities from a collected blood sample. The device can also provide dilution of the serum or plasma, or addition of an agent. Pipette extraction of diluted or undiluted blood plasma or serum from the device can also be achieved via a septum. The device permits all functions to be performed rapidly, without exposure of personnel to needles, and with minimum danger of exposure of the operator to the sample or contamination of the sample while enabling standard evacuated collection tubes to be used.

In preferred implementations, a blood separation device in the form of a cylindrical tubular assembly is provided that employs filtration to produce as much as a milliliter volume of blood plasma or serum, by simple back and forth relative movements of movable parts of the device. The movements produce air flow that pressurizes the previously evacuated collection tube, and forces blood to flow from the collection device and through the filter without exposure to the outside. In certain forms of the device, a preset level of dilution of the sample is achieved within the device.

The major benefits offered by such devices are:
Simplicity of operation,
Protection of the operator from exposure,
Freedom of contamination of the sample.

An alternate design simplifies sample dilution. A specific volume of buffer or other fluid is stored in a sealed graduated elongated collection chamber of the device. In this case, a pre-determined volume of filtered sample is introduced into the chamber.

In some applications the evacuated collection tube (Vacutainer™) is provided with material in the form of a surface coating or as a liquid that prevents blood clotting, or that offers dilution, or that alters the viscosity or other properties of the recovered fluid.

In its presently preferred implementations, the device comprises a tube-shaped main body closed at one end by a screwed-on small filtrate receptacle. The other end is open, exposing within the main body, a free sliding piston-like member, e.g., a short “poppet,” which is sealed to the inside wall of the main body. The piston is traversed through its center by a fixed, sharp hypodermic needle which protrudes outwardly. The needle is exposed to pierce the end seal of an evacuated collection tube. In the region of the main body of the device, between the poppet and the sample receptacle, is a filter assembly, the “cage”, through which the liquid is forced to pass, e.g., for removing blood cells.

The device or various of its principles have other potential uses enabling introduction of a sample container to a device, and operating the device to produce a liquid, e.g. a toxic liquid, from which a filterable substance has been accurately removed or to which an agent has been added.

According to a particular aspect of invention, a device is provided which includes a pump constructed to transfer liquid out of a partially filled, predetermined portable sealed container, the device defining a sleeve, a liquid receptacle communicating with the sleeve, a piston member including at least one seal ring slideably disposed within the sleeve, the piston, sleeve and liquid receptacle forming a closed volume, the piston constructed to couple with the portable container to form a movable assembly within the sleeve, the piston including a passage for enabling fluid communication between the closed volume and the portable container, whereby, forcing the movable assembly in a first direction toward the liquid receptacle can force compressed air captured in the closed volume into the portable container in a first action tending to equilibrate fluid pressures between the closed volume and the sealed container, and releasing the movable assembly enables compressed air captured in the closed volume to move the assembly in pressure-relieving direction opposite to the first direction, so that residual air pressure above liquid within the portable container is effective to force liquid in the portable container to move through the passage into the closed volume in a second action tending to equilibrate fluid pressures between the sealed container and the closed volume.

Preferred implementations have one or more of the following features:

The device includes an actuatable pressure relief device associated with the closed volume, constructed, when actuated, to vent the closed volume and enable further movement of liquid from the container in a third action tending to equilibrate fluid pressures between the fluid container and the now-vented closed volume, and enable movement of the piston in the first direction, without air pressure resistance, to force liquid toward the receptacle.

The device incorporates a filter or filter material to which liquid entering the closed volume is exposed, in preferred cases the device incorporating filter material selected and arranged to filter liquid in the form of blood, or the device incorporating filter material carrying a capture agent selected to remove a constituent of the liquid or the device incorporating filter material carrying an agent exposed to be dispensed into the liquid in which the agent may be a desiccated bio-active substance.

The device that incorporates a filter or filter material includes an actuatable pressure relief device associated with the closed volume, the pressure release device constructed, when actuated, to vent the closed volume and enable further movement of liquid from the container in a third action tending to equilibrate fluid pressures between the fluid container and the now-vented closed volume.

Also in the case of the device being provided with a filter or filter material, the device is constructed to enable flow of liquid forced by fluid pressure from the first container to enter into a space preceding the filter or filter material, the device including an actuatable pressure relief device associated with the closed volume, the pressure release device constructed, when actuated, to vent the closed volume and enable movement of the piston, without air pressure resistance, to force liquid through the filter or filter material toward the receptacle.

In cases employing an actuatable pressure relief device, the relief device comprises a threaded connection capable of being loosened to enable passage of air, in preferred cases the relief device being combined with material selected and positioned to allow passage of air through the threaded connection but to prevent liquid from reaching the threaded connection.

In cases in which the device with the pressure relief device is also provided with a threaded cover, succeeding clockwise and counter-clockwise screw threads are so associated with the pressure relief device and cover as to ensure that the threaded connections are opened sequentially, for instance a first screw thread enables unsealing and venting a filtrate collecting chamber to permit flow through a filter or filter material, and a second screw thread of opposite hand is associated with the cover that is screwed to close an access port, screwing the cover to close the access port being arranged to force closing of the vent.

The sleeve of the device is constructed to be hand held and to enable the portable sealed container to be thrust by hand into the sleeve to couple with the piston and produce the movements in the first direction.

The predetermined portable sealed container is a collection tube terminated in a penetrable end seal, the piston carrying a fixed, hollow penetrating needle having a protruding end exposed to penetrate the end seal during the first movement in the first direction, to enable the coupling of the piston with the predetermined container and to provide the fluid passage between the closed volume and the interior of the container, in certain preferred cases the sleeve is constructed to receive the collection tube in the form of an evacuated blood collection tube.

The device is constructed to enable filtrate to be pipetted out of a filtrate collection chamber through a septum.

The device includes pre-stored dilution fluid or reagent positioned to be mixed with liquid removed from the container, as an example dilution liquid is positioned in an end cap isolated from the liquid receptacle by a septum having a burst pressure that enables flow through the septum when the burst pressure is exceeded, the device enabling selective introduction of the liquid from the container to the dilution or reagent liquid by pressure applied to the piston.

The device in the form of a separation device comprises: (1) a main tubular body having an elongated cylindrical central passage forming the sleeve, the sleeve being open at an upper end to receive the access seal end of a collection tube and closed at its lower end by the liquid receptacle in the form of a sample collection chamber; (2) the piston slideably held in sealed relation within the cylindrical passage, the piston being traversed by a fixed hollow, longitudinally arranged hypodermic tube selected to permit air movement across the piston and having a piercing end directed outwardly, to confront the access seal of the collection tube; (3) and a filter communicating with the main body, a function of which is to permit only liquid to discharge to the collection chamber; the collection chamber arranged to retain filtrate, such as plasma or serum or sample after passing through the filter. In preferred forms the piston is in the form of a poppet element of axial length of the order of the diameter of the sleeve passage. In preferred forms the filter comprises a filter cage element shaped as a cylindrical cup with its closed end formed as a coarse sieve, its cylindrical surface tightly fitted to the inside surface of the tubular main body, the cage holding a mass of glass fiber filter material and having its other end closed with a filter sheet, in certain implementations the collection chamber is attached to the main tubular body via a coarse thread and a seal which hermetically closes the lower end when compressed and permits air movement through the threads when loosened.

A method is provided of obtaining a filtrate from blood employing the filter device comprising the steps of (a) obtaining a blood sample within an evacuated collection tube having an end sealed with a penetrable seal, (b) holding the filter device vertically, open end up, and introducing the collection tube with sealed end down, and pressing the collection tube down into the sleeve to couple with the slideable piston, then releasing the downward pressure on collection tube, (c) during downward motion some of the compressed captured air beneath the piston entering the collection tube through the passage and bubbles to the top of collection tube, and upon release of the downward pressure, the coupled assembly of collection tube and piston rising due to expansion of air captured in the closed volume, meanwhile, pressure within the collection tube having become higher than that below the assembly, causing blood to be forced out of the collection tube, into the space below, (d) optionally repeating the pressing down step at least once, each cycle causing more air to enter and raise the pressure within the collection tube, then more blood to be forced downwardly, out of the collection tube, (e) subsequently venting the closed space below the piston, (f) repeating the pressing down step once more, with no opposing air pressure, the piston acting to force blood through the filter, and the filtrate (plasma or serum) to enter the collection chamber; also, super atmospheric pressure within the collection tube causing more blood to leave the collection tube and the liquid component to be pushed by the piston through the filter to enter the collection chamber. In certain implementations the closed space is vented by partially unscrewing a bottom collection chamber one or two turns, the threads being coarse to permit air to escape as a cooperating seal formed by an O ring is freed; certain implementations include fully unscrewing a cover of the collection chamber and pipetting a desired volume of filtrate through an exposed septum followed by closing the separation device with the supplied cover and discarding or archiving the unit.

The method and device are employed in filtering a blood sample followed by conducting an assay with the filtrate. In certain implementations, the assay is conducted by flowing the filtrate or liquid derived from the filtrate over a capture surface having a two dimensional array of spots of protein capture reagents or other array.

Other features will be understood from the claims, drawings and the following descriptions.

### DESCRIPTION OF DRAWINGS

FIG. 1 is a longitudinal cross-section of a filter device assembly and an evacuated collection tube in position to be inserted into the filter device, here the device shown fitted with a filtrate collection assembly having an access septum.

FIG. 2 is a side view, FIG. 2A a detailed axial cross-section, FIG. 2B an end view and FIG. 2C a detail view of the main body of the filter device of FIG. 1.

FIG. 3A shows, in axial cross-section, a liquid collection receptacle for the device of FIG. 1; FIG. 3B shows, in axial cross-section, a filtrate collection assembly for the device of FIG. 1 having a septum through which liquid can be withdrawn and FIG. 3C shows, in axial cross-section, an alternative liquid collection receptacle for the device comprising a narrow metering tube.

FIG. 4 is a side view, FIG. 4A an end view, and FIG. 4B an axial cross section view (the latter with hypodermic needle and O rings installed), of the poppet/piston assembly for the device of FIG. 1.

FIG. 5 shows, in axial cross-section, a filter assembly for the device of FIG. 1.

FIGS. 6A to 6G show the position of various elements of the assembly as the filtering process takes place.

FIG. 7 is an exploded cross-section view, FIG. 7A an end view and FIG. 7B a fragmentary assembled view of a filter assembly which includes a filter cage for holding glass fiber filter and a final filter.

FIG. 8 is a fragmentary axial cross section of the lower end of a filtrate collection assembly having a closed filtrate collection chamber for serum or plasma, an access septum and a removable cover.

FIG. 9 is a fragmentary axial cross section of the lower end of the construction of FIG. 8 having the cover removed to expose the access septum to the filtrate collection chamber and illustrating pipette extraction.

FIG. 10 is a fragmentary axial cross section of the lower end of an alternative construction having a graduated filtrate collection chamber.

FIG. 11 is a fragmentary axial cross section of the lower end of an alternative construction having a graduated filtrate collection chamber (e.g. for serum or plasma) partially pre-filled with a defined volume of reagent.

FIG. 12 is a diagrammatic plan view of the main body of an assay cassette having an array of capture reagents with which filtrate from the filtering device is useful. The Figure is FIG. 4 from provisional U.S. Patent Application 61/030,276, filed Feb. 21, 2008, the entire contents of which are incorporated herein by reference.

Like reference symbols in the various drawings indicate like elements.

### DETAILED DESCRIPTION

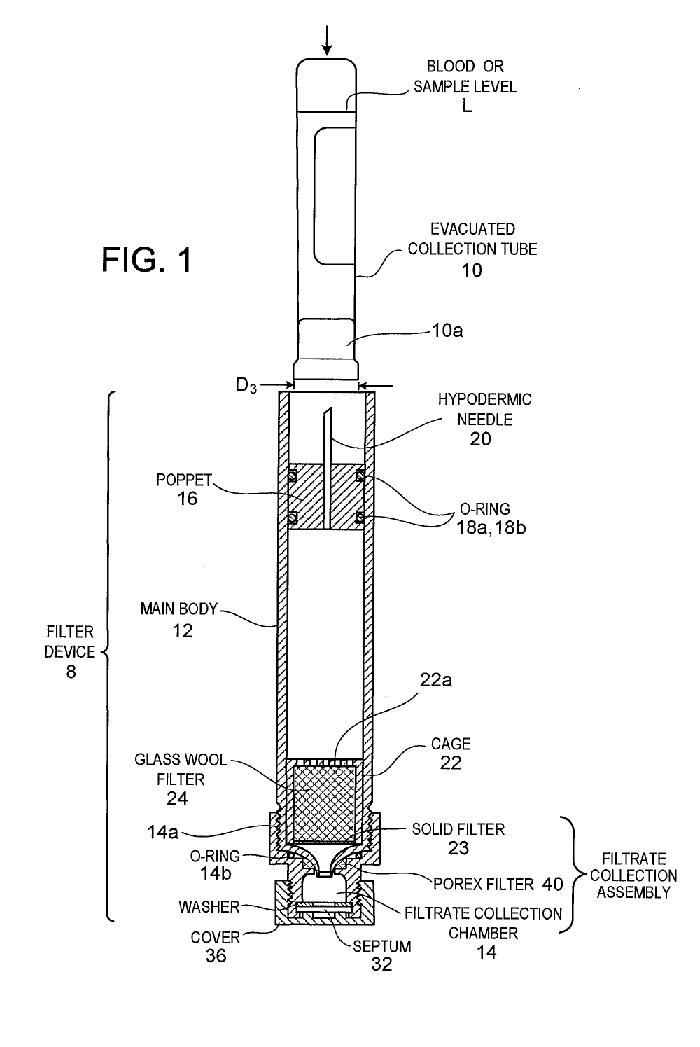

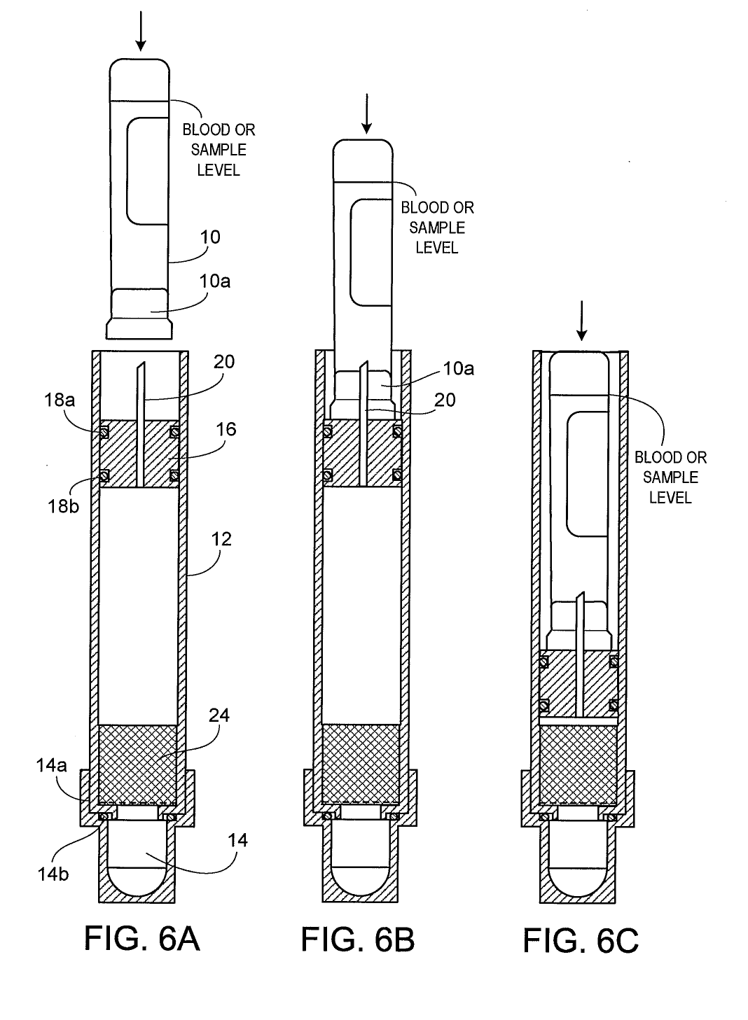

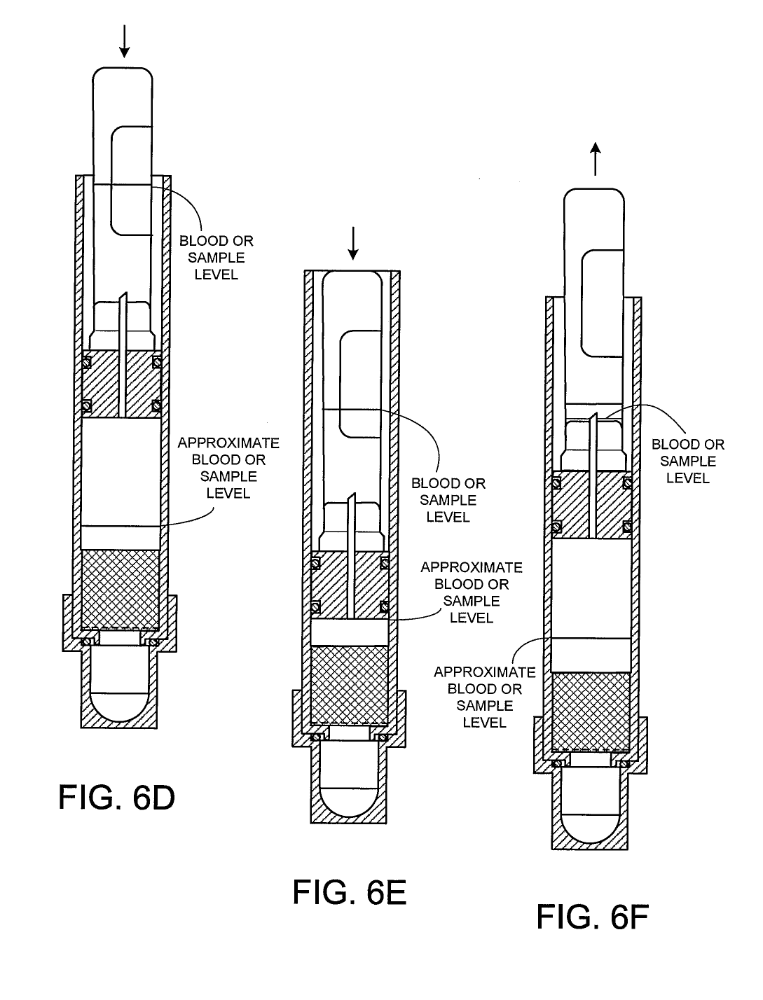

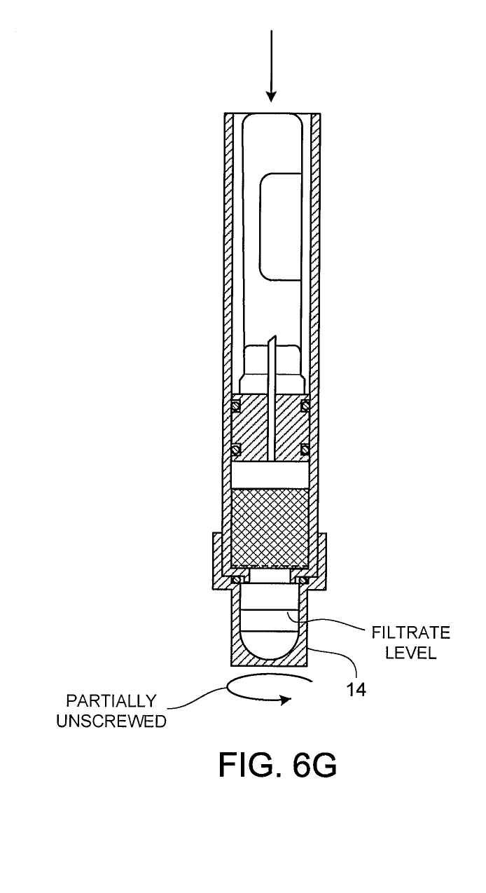

Referring to FIGS. 1 and 6A to 6G, in the preferred implementations of the figures a filter device 8 suitable for blood separation is constructed to operate with a standard evacuated blood collection tube 10 (Vacutainer™) which, at its access end, has a needle-pierceable soft rubber seal member 10a or other penetrable seal that is capable of self-sealing after being penetrated by a needle.

The filter device 8 comprises four major components:
1. A main cylindrical tube-like body 12 which has an elongated central passage that is open at its “upper end” to receive the access end of the collection tube 10 and is constructed to be closed at its “lower end” by structure defining a filtrate collection chamber or receptacle 14.
2. A cylindrically shaped “poppet” element 16 that is slideably held in sealed relation within the cylindrical passage of main body 12. In this preferred implementation, poppet element 16 is positioned in axial alignment with the passage by two axially spaced-apart O rings 18a, b, (or in other embodiments by at least one O ring or equivalent seal and alignment guide), in a piston like manner. Poppet element 16 is traversed centrally by a fixed hollow, longitudinally arranged hypodermic tube needle 20 which permits air movement across the poppet element. A sharp, piercing end of the needle is directed outwardly, to confront the seal member 10a of the collection tube 10.
3. A filter cage element 22 that is shaped as a cylindrical cup with its closed end 22a formed as a coarse sieve. Its cylindrical surface is tightly fitted to the inside surface of main body 12. The cage holds a mass 24 of glass fiber filter material (“glass wool”) and has its other end closed with a film shaped filter 23 a function of which is to permit only fluid to discharge to the collection chamber 14.
4. A collection chamber 14 in which the filtrate, such as plasma or serum or sample is retained. Collection chamber 14 is typically attached to the main body 12 via a coarse thread 14a and seal 14b such as an O ring which hermetically closes the lower end when compressed. A number of variations of the collection chamber are suggested below.

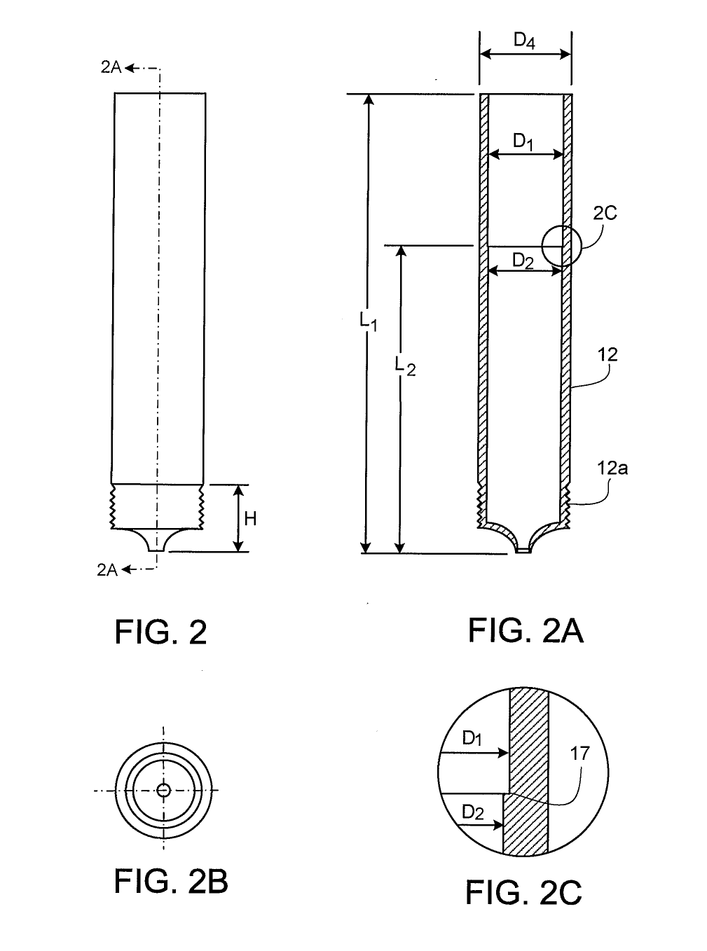

The separation process for blood is quite simple and may require about a minute:
1. Obtain a blood sample within the conventional evacuated collection tube 10, (Vacutainer™). When inverted with its rubber access seal 10a down, blood may reach level L, occupying 70% of the collection space within the tube.
2. (a) Holding the filter device 8 vertically, open end up, introduce the inverted collection tube 10 and press it gently down into the main separator tube body 12, pushing the poppet element past the commencement of restraint 17 (FIGS. 2 and 2C) to a stop. (The first time the poppet element encounters restraint, needle 20 of the restrained poppet 16 penetrates the downward moving rubber seal 10a to connect the collection tube 10 and poppet into an assembly that remains together throughout further operation). The downward stroke of the poppet 16 causes air below to be compressed. In a first equilibrating action, some of this compressed air passes from beneath poppet 16 through hypodermic needle tube 20 and bubbles to the top of the space within the collection tube 10, raising the air pressure within tube 10. (b) Then release the collection tube 10, while holding body 12 of device 8. The connected assembly of collection tube 10 and poppet 16 automatically is forced to rise to a position close to the original position due to expansion of the compressed air captured between the connected assembly and the closed lower end of the main body 12. With the occurrence of this expansion, air pressure within the collection tube 10 becomes relatively higher than that below the returning assembly. This sets up a second automatic equilibrating action, in which the higher air pressure in the collection tube 10 forces flow of blood out of the collection tube 10, downwardly through the hypodermic needle 20, into the space below the poppet 16, above the filter material 24.
3. Repeat steps 2(a) and 2(b) one, two or three times depending upon the amount of filtrate desired, each cycle causing (2a) more air to enter to temporarily raise the pressure within collection tube 10 in the first equilibrating action, then (2b) more blood to be forced downwardly, out of the collection tube 10, into the space below, by the second equilibrating action.
4. Partially unscrew the bottom collection chamber 14 one or two turns. The threads are coarse to permit air to escape as the O ring 14b is freed and its seal broken.
5. Repeat step 2(a) once more. With no opposing pressure of captured air, poppet 16 acts as a discharge piston to force the below blood through the filter 24, 23, and the filtrate (e.g., plasma or serum) into the collection chamber 14. Also, superatmospheric pressure within the collection tube 10 causes more blood to leave collection tube 10 and the fluid component to be pushed through the filter to enter the collection chamber 14. Blood clots, if any, will be retained on top of the filter cage.
6. In the case of use of the filtrate collection assembly of FIGS. 1, 3B, 8 and 9, fully unscrew and remove the cover 36 and pipette a desired volume of filtrate from collection chamber through an exposed septum 32.
7. Close the filter device with the supplied cover 36 and discard or archive the unit.

Blood Collection; Evacuated Collection Tube (Vacutainer™)

Referring to FIGS. 1 and 6A-6G, in preferred implementations blood is collected from a patient through a vein puncture device into a standard evacuated collection tube 10 such as a Vacutainer™ (Becton Dickinson), preferably container model 10.25×47, 10.25×64 or 10.25×82 with draw capacity of 1.8, 3.0, 3.2 ml respectively, each having a needle-penetrable access seal. The collection tube chosen reflects the volume of plasma or serum required. The tube commonly holds a small volume of material intended to prevent clotting of the blood, occupying as much as 10% of the volume of the blood.

The air pressure within the evacuated collection tube 10 commences at approximately 30% of sea level atmospheric pressure. When correctly used, tube 10 fills to approximately 70% of its volume with blood, holding air in approximately 30% of the volume, at pressure now close to atmospheric pressure. The evacuated collection tube is then separated from the vein puncture device.

Main Body 12

Referring to FIGS. 1, 2 and 2A, the internal diameter of the main body 12 is slightly larger than the diameter D₃ of the evacuated collection tube (Vacutainer™) such that the collection tube can be installed without difficulty with alignment. In a preferred implementation collection tube 10 is approximately 10.25 mm in outside maximum diameter, D₃. The main body 12 of the blood separator is approximately 3 inches long, L₁, made of a transparent plastic with an inside diameter D₂ approximately 0.500 inch and an outside diameter D₄ of ⅝ inch. The upper portion of body 12, above dimension L₂ may be enlarged to 0.505 inch inside diameter, D₁. The smaller dimension D₂ in the region below this is intended to create a predetermined holding restraint acting on O rings 18a and 18b of the poppet for instance of about 2 pound. This is in excess of the resistance force required to cause hypodermic needle 20 to pierce the downwardly moving rubber seal 10a of the collection tube, a force less than about 2 pounds in a typical system. The predetermined holding restraint force is sized to be overcome by resilient deformation of the “0” rings. Thus an increased hand force on the collection tube 10 downward propels “poppet” 16, beyond step 17, through the main body.

When commencing use, collection tube 10 is about ⅔ filled with blood. It is inserted in the body 12 of the device and pushed inwardly with sufficient force to impale the septum on the needle and then to proceed downwardly to pressurize captured air, forcing air to pass into the collection tube, thus pressurizing its liquid content and the void space above the liquid.

The Poppet Element 16

Referring to FIGS. 1, 4-4B and FIGS. 6A-6G, the piston, in preferred form the poppet element 16, with its needle, has 3 functions:
Pierce the seal 10a of the collection tube 10,
Pressurize the air in the collection tube to transfer blood or other liquid out,
Force the blood or other liquid through the filter 24, 23 and into the filtrate (e.g. plasma or serum) collector 14.

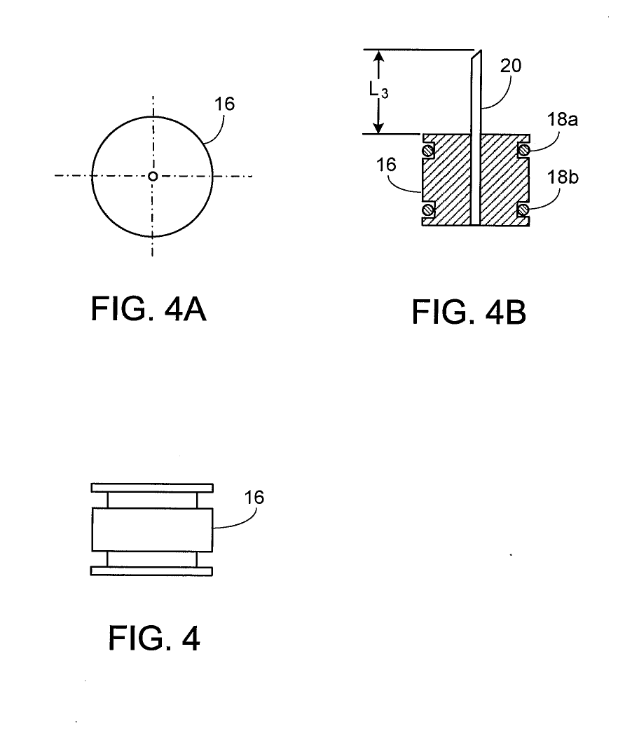

The poppet 16 is a short rod, its length preferably of the order of its diameter, with two annular grooves (FIG. 4), held in place with two O rings 18a, 18b, FIG. 4B, installed in the grooves. The grooves are separated axially by approximately ½ diameter D₂ of the main body internal diameter in order to keep the poppet approximately aligned. The poppet is traversed by a fixed hypodermic needle tubing 20 of approximately 0.036 inch outer diameter with a sharp protruding free length, L₃, approximately ½ inch, sufficient to pierce through and extend slightly beyond the rubber seal 10a, into the collection tube 10 (Vacutainer™)

Prior to use, the poppet 16 with the sharp end of the hypodermic tubing 20 protruding, rests near the entrance of the device but enclosed sufficiently within such that a user would not reach it accidentally. It rests within a slightly enlarged region, typically with diameter of 0.505 inch, such that the force to displace it further downward exceeds the force required to impale the seal 10a by the protruding hypodermic tubing 20.

The two O rings 18a, 18b align the poppet and offer a pressure tight seal with main body 12 such that pushing the collection tube 10 (Vacutainer™) further within the main body compresses the air in the device as well as within the collection tube 10. The volume within the device is preferably defined such that pushing the collection tube 10 to the end of its permitted travel pressurizes the device and collection tube 10 to approximately 3.5 atmospheres.

The Filter Assembly 22, 22A, 24, 23

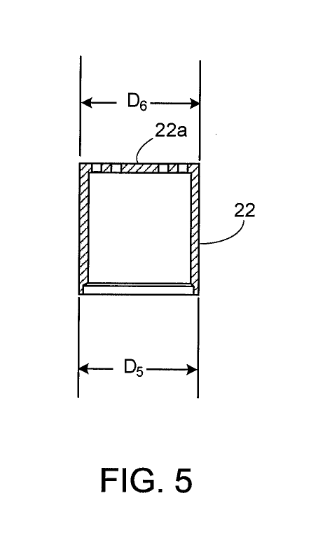

Referring to FIGS. 1, 5 and 7 the filter, when adapted to filter, e.g., blood, is preferably built as a subassembly bounded by filter cage 22 that can be tightly fitted within the main body 12. Cage 22 contains glass wool filter material 24. The filter cage 22 is preferably shaped as a slightly tapered cylinder closed at its upper end with a very coarse perforated filter 22a with as many holes as practical, each of approximately 1 mm opening. This filter 22a prevents clots from passing but also retains in place the glass fiber filter material 24 when decompression occurs by the upward movement of poppet element 16. The filter cage 20 and the coarse filter 22a preferably comprise a single molded part of synthetic resin. In a preferred implementation the lower end of the cage is of slightly larger diameter D₅ than the upper end of the cage of diameter D₆. For instance the cage is formed of plasticized PVC which is malleable, and the cage is press-fit from below into the passage of the main body 12 to form a seal. For instance D₅=0.503 inch and D₆=0.495 inch.

The filter cage 22 may also serve as a stop for the poppet's travel, but its main function is to block possible clots of red blood cells from entering the glass fiber section and blocking it.

The middle region of filter cage 22 is approximately 1 diameter long, 0.5 to 0.6 inch long in the preferred implementation. It holds the volume of glass fiber 24 in an approximately uniform distribution

A finer filter section 23 is provided at the exit end of filter cage 22 to prevent loose fiber elements of the glass fiber filter from escaping into the collection chamber 14.

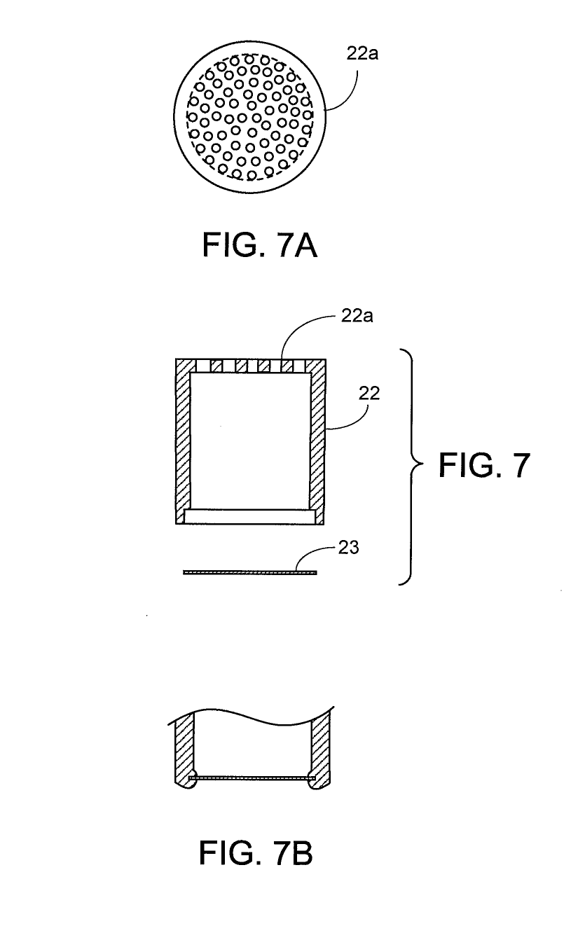

For this purpose, filter cage 22 is closed with a filter material 23 such as Versapor 1200 or Versapor 3000 filter material from VWR international. This is similar to a filter paper with 1.2 or 3 micron porosity. This filter may be bonded to close the filter cage 22 as shown in FIG. 7B or placed below it and pushed against a seal such as an O ring or a rubber ring, not shown.

In some applications, the glass filter or section of the glass filter is coated with a reagent specifically designed to capture some or most of specific molecules that should be excluded from the sample. The high density of fibers and the small cross dimensions and long flow dimensions of the meandering pathways through the filter provide intimate exposure of the filter material to the liquid passing through for such reactions.

In addition a number of features may be incorporated within the main body in order to retain the filter material located in the filter section. The filter material may include a number of filter media with different properties, some properties being filtering properties and others may have molecular interaction capability with the blood to be processed. For instance, desiccated bio-active reagents having long storage life may be carried by a layer of filter material for release to the liquid or for interaction with designated constituents of the fluid passing through the filter material for labeling, as by fluorescent labels, capture by immobilized capture agents or for other purposes.

The Filtrate Collection Assembly

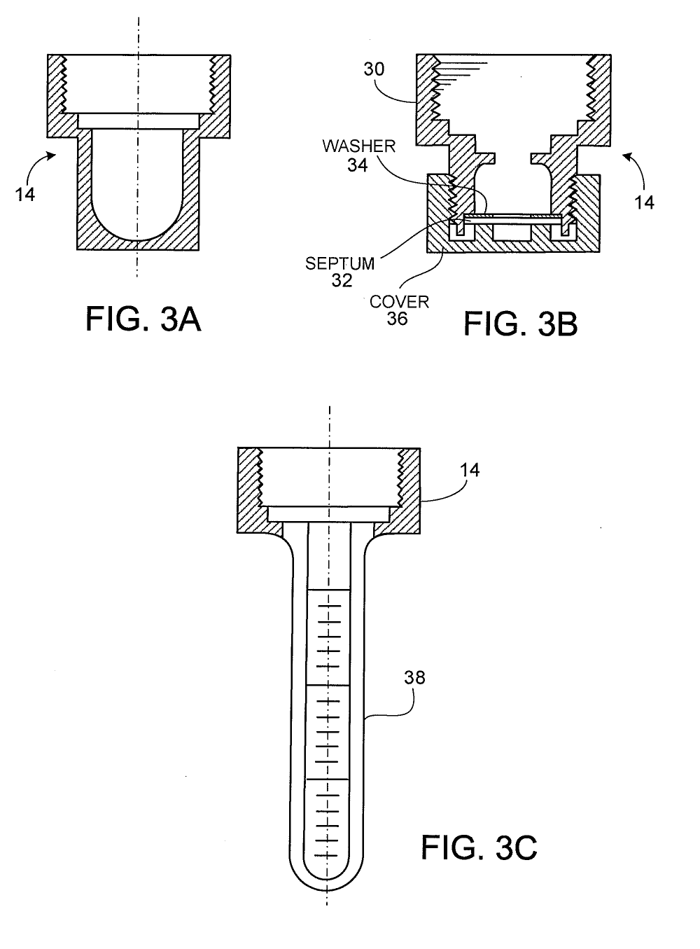

Referring to FIGS. 1, 3A-3C 6A to 6G and 8-11, the sample collection assembly of whichever form selected is hermetically sealed on the lower end of the main body 12 so that it can be pressurized. It must be constructed such that at a later stage the seal may be terminated and air can escape and blood can flow through the filter. The air can escape safely to the atmosphere but all liquids must be constrained within the chamber. A micro-porous plug of annular form such as Porex filter material compressed between the lower end of the main body 12 and mating structure of the collection chamber 14 guaranties that no liquid can escape while air can pass through the material.

An additional function of the collection assembly is to permit easy extraction of the filtrate preferably with a pipette.

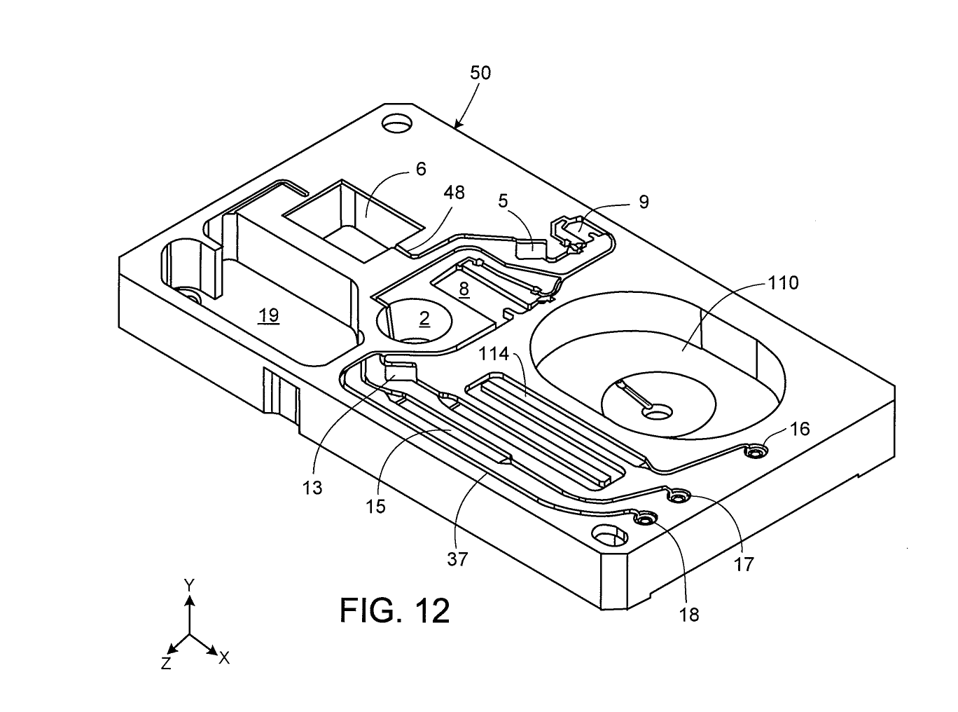

In an alternate construction, see FIGS. 3C and 11, the collection assembly may hold, in a sealed manner, a specified volume of buffer or reagent such that a predetermined dilution of the filtrate can take place within the device.

In preferred implementations the filtrate collection assembly is composed of a chamber that is fastened to the main body 12 via a coarse clockwise thread loosely fitted, such as ½-12 NC. As shown in FIGS. 1 and 6A, the chamber is spaced with an O ring 14b that seals hermetically the two parts when the chamber is fully tightened. As shown in FIGS. 1 and a micro-porous ring-shaped filter of Porex material 40 for instance is lodged between the two parts to guaranty that no liquid can escape.

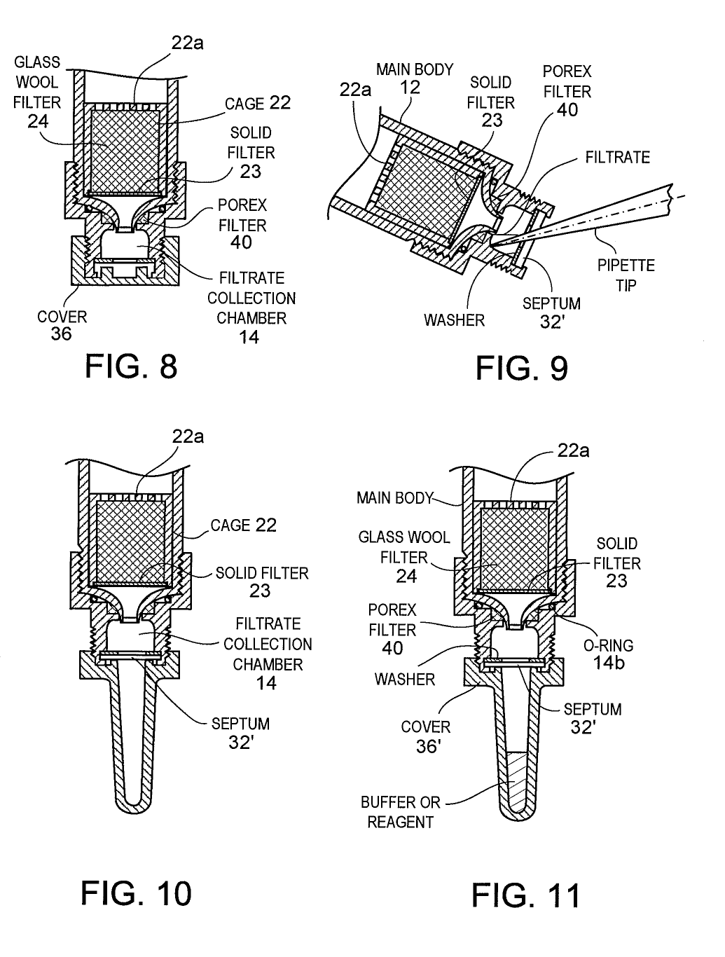

In preferred implementations, see FIGS. 1 and 8, the chamber is closed at its outer end with a cover 36 which compresses and seals a septum 32. The septum is preferably pierced at its center so that when the cover is removed, a pipette (or a syringe) can be entered to extract the filtrate.

The cover 36 is fastened to the collection chamber 14 with a counterclockwise thread such as ½-20 NF or 7/16-20 NF. The counter clockwise screw thread is employed so that removing the cover 36 causes the chamber 14 to tighten its seal against the main body 12 of the device.

Referring to FIGS. 3C, 10 and 11, in other implementations, the cover 36′ or 38 of transparent material is shaped in an elongated form with volume indications so that a fixed volume of filtrate may be collected by the user. In this condition, after the collection chamber has received all the filtrate, the cover 36′ or 38 and the collection chamber are again tightened and filtrate is forced through the perforated septum by pumping movement of the interconnected collection tube 10 and poppet 16 with sufficient force to exceed the fluid “burst” pressure of the perforated, self-sealing septum. The filtrate can than be pipetted out when this elongate cover is removed. Suitable covers may be used to seal both the separated, liquid-filled “cover” 36′, 38 and the collection chamber 14 of the device.

Referring to FIG. 11, in another implementation, the elongated cover 36′ holds a pre-determined volume of diluent, such as buffer or distilled water. The same process described above can be used to transfer a defined volume of filtrate into the volume by which the filtrate is diluted to the predetermined degree desired. Likewise the pre-stored liquid may contain a reagent for the assay.

Sample Extraction

As noted above, in respect of filtering of blood, the blood is drawn from the patient in the conventional manner and the collection tube 10 is inserted vertically, seal 10a down, in the appropriate filter device 8. The open end of the filter device holds poppet element 16 in the main body with the two sealing O rings 18a and 18b, the poppet holding in its center a hollow hypodermic needle 20 that opens the inside of the device, within body 12, to atmospheric pressure. Pushing the collection tube 10 inside the filter device 8 with a force less than 1000 gram, often under 800 gram, pierces the seal 10a which links the inside of the collection tube 10 to the volume of the filter device within body 12 and closes access to atmospheric pressure. The tip of the needle then just protrudes through the seal 10a, into tube 10.

Continuous displacement of the tube 10 downwardly compresses the air within the filter device and forces air within tube 19 until a force of approximately 4 or 5 kilogram is required to reach a stop. The pressure within the device 8 and collection tube 10 reaches a level that is approximately 3.5 the atmospheric pressure and air is forced within the collection tube through the blood to the top of the tube by a first equilibrating action.

When the force bringing the parts 10 and 8 together is removed, the collection tube 10 is pushed outwardly by the trapped compressed air until the pressure within the device 8 exerts a force equivalent to the friction of the poppet 16 in the tube or about 0.8 kilo. The pressure in the device 8 is reduced to approximately one atmosphere above ambient. In a second equilibrating action, this causes the air trapped in the upper part of the collection tube to expand possibly as much as 3 times, forcing out blood into the body 12 of the device and within or above the filter material. The steps may be repeated until sufficient amount of blood has been pushed within and above the filter material.

When sufficient blood has been displaced, and the collection tube 10 fully extended outward, unscrewing the filtrate collection chamber 14 from body 12 releases the internal pressure, the captured air escaping through the relieved seal and through the loose-fitting threads. This forces some liquid through the filter and filtrate into the filtrate receptacle 14.

If it is necessary that no filtrate should enter the original filtrate receptacle, the device should be turned upside down when the serum receptacle 14 is unscrewed. An alternate receptacle can then be installed and the unit returned to the vertical with the new receptacle at the bottom.

Pushing collection tube 10 back into device 8 forces more blood through the filter, a process that may be aborted as needed or performed with a different filtrate receptacle. Such receptacle may be graduated so that a specific volume is taken.

In another implementation, the filtrate chamber may be shaped as a tube to hold a defined volume of buffer or similar dilution fluid required for a later processing of the serum or plasma. Such chamber would preferably be sealed until put in use.

In another implementation, the filtrate receptacle chamber may be fitted with a septum 32 that can readily be pierced with a pipette or a syringe to meter out a specific volume of serum.

Filter Description

Filters are commonly used to separate serum from whole blood. The use of hollow fiber filters are practical if the serum sample is small, typically under 20 microliters (U.S. Pat. Nos. 6,755,802 and 5,919,356).

The use of filters has been described where the volume and properties of the filter are able to hold the quantity of red cells that need to be separated from the blood sample.

U.S. Pat. No. 4,477,575, incorporated herein by reference, generously describes such a filter in column 10 line 56-68 and table 2:

“Separate Recovery of Plasma

A synthetic resin vessel which downwardly narrows conically (e.g. a synthetic resin tip with a piston pipette, length 5 cm., thickness 0.5 cm.) is loosely filled two thirds full with glass fibers according to the following Table 2, packing densities of 0.1 to 0.4 g./cm³ being obtained. After the upper free part has been filled with blood, the serum diffuses into the tip of the vessel. From there, an “end-to-end” capillary of 15 μ.l. capacity can be filled by attachment to the opening of the pipette tip. The plasma obtained in this manner can now be used directly for any desired analytical process.”

The glass fiber filter used in the present devices is generally as described in this patent with the addition of a 1.2 to 3 micron filter downstream that blocks any segment of glass fiber.

The glass fiber material filter may be purchased from Johns Manville or from PALL/VWR as part 288150-995 and the 0.7 micron filter as part 28149-455 from PALL/VWR.

Blood serum collection and use is subject to many variables:
The serum fraction of a blood sample in a normal control subject is similar to that among diabetic patients and ranges from approximately 45% to 70%.
Serum is used undiluted or in a diluted form with dilution ranging from 10% to 2×[adding 10% up to an equal amount of diluents]

Some assays demand a filtrate of plasma or serum from which a number of molecules have been removed. This may readily be achieved when appropriate capture agents are imbedded or otherwise immobilized in the filter material that may capture specific molecules such as fibrinogen or minimize the presence of over-expressed proteins the overabundance of which may overwhelm an assay. Amylopectia Sulfate (APS) may be such an agent that can be introduced in a dispersed manner within the glass fiber filter to capture in a distributed, non clogging manner platelets and red cells causing minimum alteration to the serum proper.

In the event a precise ratio is desirable it may not be practical to incorporate the diluting agent or reagent within the collection tube 10. The system described here offers a method for accurate dilution or reaction.

In some assays where the dilution ratio may not be critical, a dilution agent only may be incorporated in the collection tube 10.

As described in U.S. patent application 61/030,276 filed Feb. 21, 2008, incorporated by reference, a filter material may be employed to temporarily store a desiccated agent, such as an agent having bio-activity such as a suitably conjugated fluorophore label. Such filter material carrying an agent can be employed as filter 23 as a means to liquefy and dispense the agent into the filtrate. Indeed, it is possible to employ only such filter material, (omitting filters 22a and 24), and to employ the device simply as a device to dispense an agent into appropriate liquid.

Blood Protein Assay

FIG. 12 illustrates the body of a bio-chip cassette for protein. Its plan view is the size of a credit card. Chamber 2 receives the filtrate (plasma or serum) prepared as described above, with or without dilution or additives, depending upon the assay. Chamber 110 holds buffer solution that provides all other liquids for an ELISA-like assay. At chamber 6 is a reaction gap through which the liquids sequentially flow to expose a two dimensional array of spots of capture reagent applied to a solid nitrocellulose coating on a glass substrate, not shown. Spent liquid proceeds to waste chamber 19. There is a transparent window overlying the array, spaced apart by a small flow gap, not shown. After fluorescent labeling of the captured blood protein and washing by buffer liquid, the array is read by stimulating radiation passing in through the window and exited fluorescent emission passing from the labels out through the window.

A number of embodiments of the invention have been described. Nevertheless, it will be understood that various modifications may be made without departing from the spirit and scope of the invention. For example, the filter material may be selected for body fluids other than blood, and for other purposes, such as for agent dispensing, instead of for filtering; the pressure relief device may be a valve or other device that can be opened to the atmosphere instead of depending on loosening of a threaded attachment. Accordingly, other embodiments are within the scope of the following claims.

What is claimed is:

1. A device which includes a pump constructed to transfer liquid out of a partially filled, predetermined portable sealed container, the device defining a sleeve, a liquid receptacle communicating with the sleeve, a piston member including at least one seal ring slideably disposed within the sleeve, the piston, sleeve and liquid receptacle forming a closed volume, the piston constructed to couple with the portable container to form a movable assembly within the sleeve, the piston including a passage for enabling fluid communication between the closed volume and the portable container, whereby, forcing the movable assembly in a first direction toward the liquid receptacle can force compressed air captured in the closed volume into the portable container in a first action tending to equilibrate fluid pressures between the closed volume and the sealed container, and releasing the movable assembly enables compressed air captured in the closed volume to move the assembly in pressure-relieving direction opposite to the first direction, so that residual air pressure above liquid within the portable container is effective to force liquid in the portable container to move through the passage into the closed volume in a second action tending to equilibrate fluid pressures between the sealed container and the closed volume.

2. The device of claim 1 including an actuatable pressure relief device associated with the closed volume, constructed, when actuated, to vent the closed volume and enable further movement of liquid from the container in a third action tending to equilibrate fluid pressures between the fluid container and the now-vented closed volume, and enable movement of the piston in the first direction, without air pressure resistance, to force liquid toward the receptacle.

3. The device of claim 1 incorporating a filter or filter material to which liquid entering the closed volume is exposed.

4. The device of claim 3 incorporating filter material selected and arranged to filter liquid in the form of blood.

5. The device of claim 3 incorporating filter material carrying a capture agent selected to remove a constituent of the liquid.

6. The device of claim 3 incorporating filter material carrying an agent exposed to be dispensed into the liquid.

7. The device of claim 5 or 6 in which the agent is a desiccated bio-active substance.

8. The device of claim 3 including an actuatable pressure relief device associated with the closed volume, the pressure release device constructed, when actuated, to vent the closed volume and enable further movement of liquid from the container in a third action tending to equilibrate fluid pressures between the fluid container and the now-vented closed volume.

9. The device of claim 3 constructed to enable flow of liquid forced by fluid pressure from the first container to enter into a space preceding the filter or filter material, the device including an actuatable pressure relief device associated with the closed volume, the pressure release device constructed, when actuated, to vent the closed volume and enable movement of the piston, without air pressure resistance, to force liquid through the filter or filter material toward the receptacle

10. The device of 2, 8 or 9 in which the actuatable pressure relief device comprises a threaded connection capable of being loosened to enable passage of air.

11. The device of claim 10 combined with material selected and positioned to allow passage of air through the threaded connection but to prevent liquid from reaching the threaded connection.

12. The device of claim 10 including a threaded cover and wherein succeeding clockwise and counter-clockwise screw threads are so associated with the pressure relief device and cover as to ensure that the threaded connections are opened sequentially.

13. The device of claim 12 in which a first screw thread enables unsealing and venting a filtrate collecting chamber to permit flow through a filter or filter material, and a second screw thread of opposite hand is associated with the cover that is screwed to close an access port, screwing the cover to close the access port being arranged to force closing of the vent.

14. The device of claim 1, 2 or 3 in which the sleeve is constructed to be hand held and to enable the portable sealed container to be thrust by hand into the sleeve to couple with the piston and produce the movements in the first direction

15. The device of claim 1, 2 or 3 in which the predetermined portable sealed container is a collection tube terminated in a penetrable end seal, the piston carrying a fixed, hollow penetrating needle having a protruding end exposed to penetrate the end seal during the first movement in the first direction, to enable the coupling of the piston with the predetermined container and to provide the fluid passage between the closed volume and the interior of the container.

16. The device of claim 15 in which the sleeve is constructed to receive the collection tube in the form of an evacuated blood collection tube.

17. The device of claim 3 or 9 constructed to enable filtrate to be pipetted out of a filtrate collection chamber through a septum.

18. The device of claim 1, 3 or 9 including pre-stored dilution fluid or reagent positioned to be mixed with liquid removed from the container.

19. The device of claim 18 in which prestored dilution liquid or reagent is positioned in an end cap isolated from the liquid receptacle by a septum having a burst pressure that enables flow through the septum when the burst pressure is exceeded, the device enabling selective introduction of the liquid from the container to the dilution or reagent liquid by pressure applied to the piston.

20. The device of claim 3 in the form of a separation device comprising: (1) a main tubular body having an elongated cylindrical central passage forming the sleeve, the sleeve being open at an upper end to receive the access seal end of a collection tube and closed at its lower end by the liquid receptacle in the form of a sample collection chamber; (2) the piston slideably held in sealed relation within the cylindrical passage, the piston being traversed by a fixed hollow, longitudinally arranged hypodermic tube selected to permit air movement across the piston and having a piercing end directed outwardly, to confront the access seal of the collection tube; (3) and a filter communicating with the main body, a function of which is to permit only liquid to discharge to the collection chamber; the collection chamber arranged to retain filtrate, such as plasma or serum or sample after passing through the filter.

21. The device of claim 20 in which the piston is in the form of a poppet element of axial length of the order of the diameter of the sleeve passage.

22. The device of claim 20 in which the filter comprises a filter cage element shaped as a cylindrical cup with its closed end formed as a coarse sieve, its cylindrical surface tightly fitted to the inside surface of the tubular main body, the cage holding a mass of glass fiber filter material and having its other end closed with a filter sheet.

23. The device of claim 20, 21 or 22 in which the collection chamber is attached to the main tubular body 12 via a coarse thread and a seal which hermetically closes the lower end when compressed and permits air movement through the threads when loosened.

24. The method of obtaining a filtrate from blood employing the device of claim 4, comprising the steps of (a) obtaining a blood sample within an evacuated collection tube having one end sealed with a penetrable seal, (b) holding the filter device according to claim 4 vertically, open end up, and introducing the collection tube with sealed end down, and pressing the collection tube down into the sleeve to couple with the slideable piston, then releasing the downward pressure on collection tube, (c) during downward motion some of the compressed captured air beneath the piston entering the collection tube through the passage and bubbles to the top of collection tube, and upon release of the downward pressure, the coupled assembly of collection tube and piston rising due to expansion of air captured in the closed volume, meanwhile, pressure within the collection tube having become higher than that below the assembly, causing blood to be forced out of the collection tube, into the space below, (d) optionally repeating the pressing down step at least once, each cycle causing more air to enter and raise the pressure within the collection tube, then more blood to be forced downwardly, out of the collection tube, (e) subsequently venting the closed space below the piston, (f) repeating the pressing down step once more, with no opposing air pressure, the piston acting to force blood through the filter, and the filtrate (plasma or serum) to enter the collection chamber; also, super atmospheric pressure within the collection tube causing more blood to leave the collection tube and the liquid component to be pushed by the piston through the filter to enter the collection chamber.

25. The method of claim 24 in which the closed space is vented by partially unscrewing a bottom collection chamber one or two turns, the threads being coarse to permit air to escape as a cooperating seal formed by an O ring is freed.

26. The method of claim 24 or 25 including fully unscrewing a cover of the collection chamber and pipetting a desired volume of filtrate through an exposed septum followed by closing the separation device with the supplied cover and discarding or archiving the unit.

27. The method of claim 24 of filtering a blood sample followed by conducting an assay with the filtrate.

28. The method of claim 27 in which the assay is conducted by flowing the filtrate or liquid derived from the filtrate over a capture surface heaving a two dimensional array of spots of protein capture reagents or other array.
